(19) United States
(12) Patent Application Publication
(10) Pub. No.: US 2024/0069538 A1
(43) Pub. Date: Feb. 29, 2024

(54) SYSTEMS AND METHODS FOR HARNESSING LABEL SEMANTICS TO EXTRACT HIGHER PERFORMANCE UNDER NOISY LABEL FOR COMPANY TO INDUSTRY MATCHING

(71) Applicant: JPMORGAN CHASE BANK, N.A., New York, NY (US)

(72) Inventors: Abhishek MITRA, Kundalahalli (IN); Apoorva JAISWAL, Kanpur (IN); Steven LAU, New York, NY (US); Madison KING, Manhattan, NY (US); Nayeemur RAHMAN, Bengaluru (IN)

(21) Appl. No.: 18/457,993

(22) Filed: Aug. 29, 2023

(30) Foreign Application Priority Data
Aug. 29, 2022 (IN) 202211049235

(51) Int. Cl. G05B 19/418

(52) U.S. Cl. CPC G05B 19/41885; G05B 19/4183

(57) ABSTRACT

A method may include: receiving input data comprising company business descriptions, industry tags, and industry tag descriptions; creating a similarity matrix for the industry tags using a minimum labeling strategy, wherein the similarity matrix comprises a plurality of similarity scores for pairs of industry tags; sampling the industry tags using a stratified sampling method; generating a semantic textual similarity style dataset comprising triplets of the industry tag descriptions, the company business descriptions, and the similarity scores; fine-tuning a baseline language model for a semantic similarity model; training the semantic similarity model by subjecting embeddings generated for pairs of the company business description and industry tag descriptions to a cosine similarity function; creating a checkpoint model for the semantic similarity model, and inferring an industry tag for each company using the checkpoint model that generates a cosine similarity for pairs for industry tag descriptions.

### RELATED APPLICATIONS

This application claims priority to, and the benefit of, Indian Patent Application Number 202211049235, filed Aug. 29, 2022, the disclosure of which is hereby incorporated, by reference, in its entirety.

### BACKGROUND OF THE INVENTION

### 1. Field of the Invention

Embodiments are generally directed to systems and methods for harnessing label semantics to extract higher performance under noisy label for company to industry matching.

### 2. Description of the Related Art

Companies around the globe deal with various types of businesses/industries. In the finance domain, when bankers know the industry of operation of these companies, it becomes easier for them to identify potential clients and companies that deal with a particular business domain. Due to the scarce availability of the industry, identifiers associated with the companies and assignment of industry tags is performed either manually or using other computational methods. Although this assignment is a critical task in a financial institution as it impacts various financial machineries, it remains a complex task.

Typically, such industry tags are to be assigned manually by Subject Matter Experts (SME) after evaluating company business lines against the industry definitions. It becomes even more challenging as companies continue to add new businesses and newer industry definitions are formed. Given that the task of assigning industry tags is not required to be carried out often, it is reasonable to assume that an Artificial Intelligent (AI) agent could be developed to carry it out in an efficient manner. While this is an exciting prospect, the challenges appear from the need of historical patterns of such tag assignments (or Labeling).

Labeling is often considered the most expensive task in Machine Learning (ML) due to its dependency on SMEs and manual efforts. Therefore, often, in enterprise set up, an ML project encounters noisy and dependent labels. Such labels create technical hindrances for ML Models to produce robust tag assignments.

### SUMMARY OF THE INVENTION

Systems and methods for harnessing label semantics to extract higher performance under noisy label for company to industry matching are disclosed. According to an embodiment, a method may include: (1) receiving, by a computer program executed by an electronic device, input data comprising company business descriptions, industry tags, and industry tag descriptions; (2) creating, by the computer program, a similarity matrix for the industry tags using a minimum labeling strategy, wherein the similarity matrix comprises a plurality of similarity scores for pairs of industry tags; (3) sampling, by the computer program, the industry tags using a stratified sampling method; (4) generating, by the computer program, a semantic textual similarity style dataset comprising triplets of the industry tag descriptions, the company business descriptions, and the similarity scores; (5) fine-tuning, by the computer program, a baseline language model for a semantic similarity model; (6) training, by the computer program, the semantic similarity model by subjecting embeddings generated for pairs of the company business description and industry tag descriptions to a cosine similarity function; (7) creating, by the computer program, a checkpoint model for the semantic similarity model, and (8) inferring, by the computer program, an industry tag for each company using the checkpoint model, wherein the checkpoint model generates a cosine similarity for pairs for industry tag descriptions.

In one embodiment, the method may also include: evaluating, by the computer program, the checkpoint model using an Exact Match Ratio; and updating, by the computer program, the similarity matrix using cosine similarity values for the pairs of industry tag descriptions.

In one embodiment, the computer program evaluates the checkpoint model by comparing the Exact Match Ratio for the checkpoint model to a prior Exact Match Ratio for a prior model to determine improvement in the checkpoint model.

In one embodiment, the method may also include optimizing, by the computer program, hyperparameters for the checkpoint model in response to the checkpoint model not improving relative to the prior model.

In one embodiment, the method may also include receiving, by the computer program, feedback for the inferred industry tags.

In one embodiment, wherein the similarity scores are measured on a scale of between 0 and 5.

In one embodiment, the minimum labeling strategy receives between 10 percent and 15 percent of the similarity scores from subject matter experts.

In one embodiment, the stratified sampling method populates samples per similarity score such that each industry tag has a sample.

In one embodiment, the baseline language model comprises a Robustly Optimized BERT Pre-training Approach model.

In one embodiment, the baseline language model is fine-tuned with text data that reference companies, industries, and/or industry taxonomies.

According to another embodiment, a non-transitory computer readable storage medium, including instructions stored thereon, which when read and executed by one or more computer processors, cause the one or more computer processors to perform steps comprising: receiving input data comprising company business descriptions, industry tags, and industry tag descriptions; creating a similarity matrix for the industry tags using a minimum labeling strategy, wherein the similarity matrix comprises a plurality of similarity scores for pairs of industry tags; sampling the industry tags using a stratified sampling method; generating a semantic textual similarity style dataset comprising triplets of the industry tag descriptions, the company business descriptions, and the similarity scores; fine-tuning a baseline language model for a semantic similarity model; training the semantic similarity model by subjecting embeddings generated for pairs of the company business description and industry tag descriptions to a cosine similarity function; creating checkpoint model for the semantic similarity model, and inferring an industry tag for each company using the checkpoint model, wherein the checkpoint model generates a cosine similarity for pairs for industry tag descriptions.

In one embodiment, the non-transitory computer readable storage medium may also include instructions stored thereon, which when read and executed by one or more computer processors, cause the one or more computer processors to perform steps comprising: evaluating the checkpoint model using an Exact Match Ratio; and updating the similarity matrix using cosine similarity values for the pairs of industry tag descriptions.

In one embodiment, the checkpoint model is evaluated by comparing the Exact Match Ratio for the checkpoint model to a prior Exact Match Ratio for a prior model to determine improvement in the checkpoint model.

In one embodiment, the non-transitory computer readable storage medium may also include instructions stored thereon, which when read and executed by one or more computer processors, cause the one or more computer processors to perform steps comprising: optimizing hyperparameters for the checkpoint model in response to the checkpoint model not improving relative to the prior model.

In one embodiment, the non-transitory computer readable storage medium may also include instructions stored thereon, which when read and executed by one or more computer processors, cause the one or more computer processors to perform steps comprising: receiving feedback for the inferred industry tags.

In one embodiment, the similarity scores are measured on a scale of between 0 and 5.

In one embodiment, the minimum labeling strategy receives between 10 percent and 15 percent of the similarity scores from subject matter experts.

In one embodiment, the stratified sampling method populates samples per similarity score such that each industry tag has a sample.

In one embodiment, the baseline language model comprises a Robustly Optimized BERT Pre-training Approach model.

In one embodiment, the baseline language model is fine-tuned with text data that reference companies, industries, and/or industry taxonomies.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for harnessing label semantics to extract higher performance under noisy label for company to industry matching according to an embodiment;

FIGS. 2A and 2B depict a method for harnessing label semantics to extract higher performance under noisy label for company to industry matching according to an embodiment; and

FIG. 3 depicts an exemplary computing system for implementing aspects of the present disclosure.

### DETAILED DESCRIPTION OF PREFERRED EMBODIMENTS

Systems and methods for harnessing label semantics to extract higher performance under noisy label for company to industry matching are disclosed.

Embodiments may use semantic similarity matching as an alternative to multi label text classification, while making use of a label similarity matrix and a minimum labelling strategy. For example, embodiments may use semantic similarity matching as an alternative to multi label text classification with noisy labels. In embodiments, label dependencies may be integrated into semantic similarity model through a rated Label Similarity Matrix (LSM). This may reduce human effort through minimum labelling strategy.

In an exemplary implementation, embodiments may tag companies with industry tags. Embodiments may also be used in many applications that require the industry of a company to be known.

Embodiments may provide a text classification machine learning algorithm that intakes a textual description of a company's business and outputs one or more appropriate industry classes (or tags). The machine learning pipeline in multi label classification with noisy labels domain may use deep learning based semantic matching with label similarity matrix and may achieve robust results against gold standard ground truth.

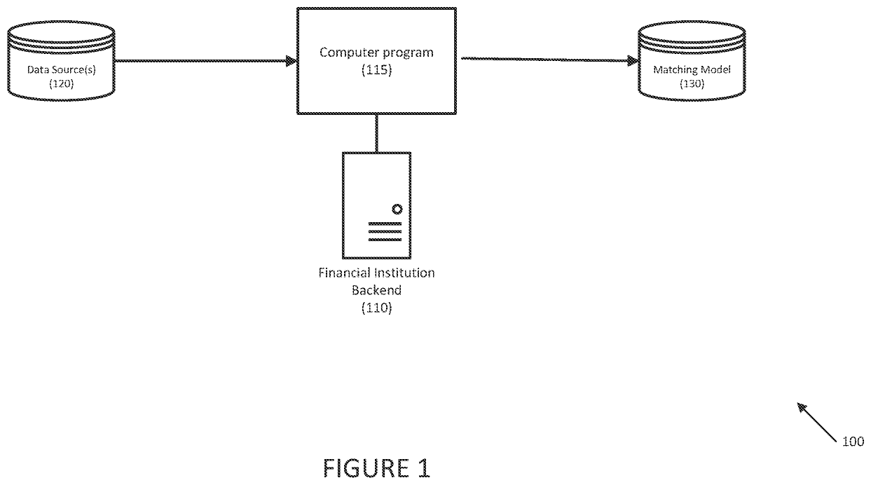

Referring to FIG. 1, a system for harnessing label semantics to extract higher performance under noisy label for company to industry matching is disclosed according to an embodiment. System 100 may include electronic device 110, which may be any suitable electronic device, such as servers (e.g., physical and/or cloud-based), computers (e.g., workstations, desktops, laptops, notebooks, tablets, etc.), smart devices, Internet of Things (IoT) appliances, etc.

Electronic device 110 may execute computer program 115, which may receive data from one or more data sources 120. The data in data sources 120 may include company business descriptions (CBD), which are textual descriptions that describes a company's business e.g., “ABC Pvt. Ltd. is a leading payment application based out of Bengaluru. It offers financial services through its mobile application and website for customers and vendors.”

The data may also include industry tag(s) which are a set of names corresponding to industry descriptions. A company can have one or more industry tags based on its businesses. For example, ABC Pvt. Ltd. may have the industry tag as “Financial Technologies and Payment.” Industry tags that are not mutually exclusive, may be referred to as “noisy labels.”

The data may also include an industry tag description (ITD), which is a textual description that defines an industry tag. For example, a description of the Tag Financial Technology may be “Financial technology companies integrate predictive behavioral analytics, data driven marketing, blockchain to provide banking services.”

The input data may include other or different information as is necessary and/or desired.

Computer program 115 may receive data from data source(s) 120, and may generate a model to match companies with industries.

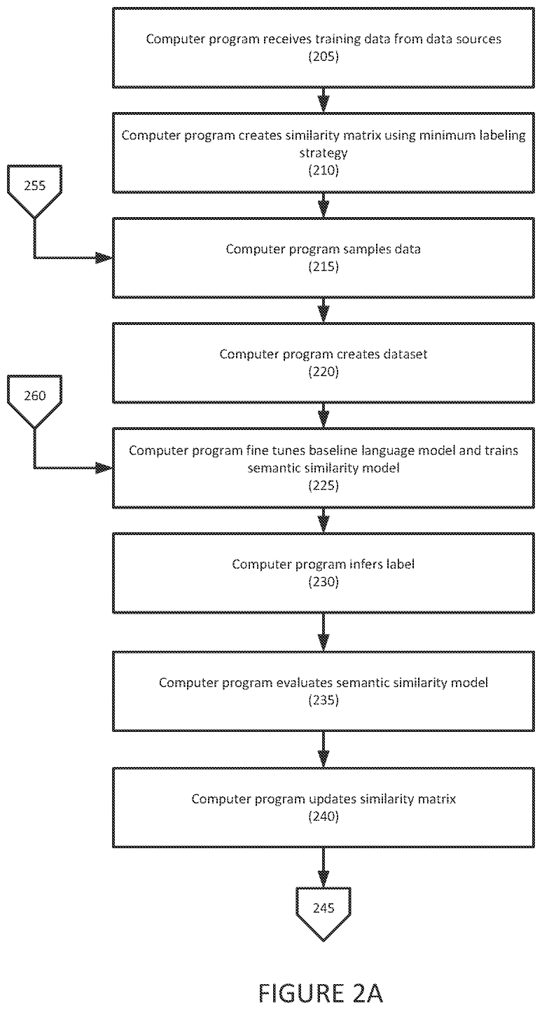

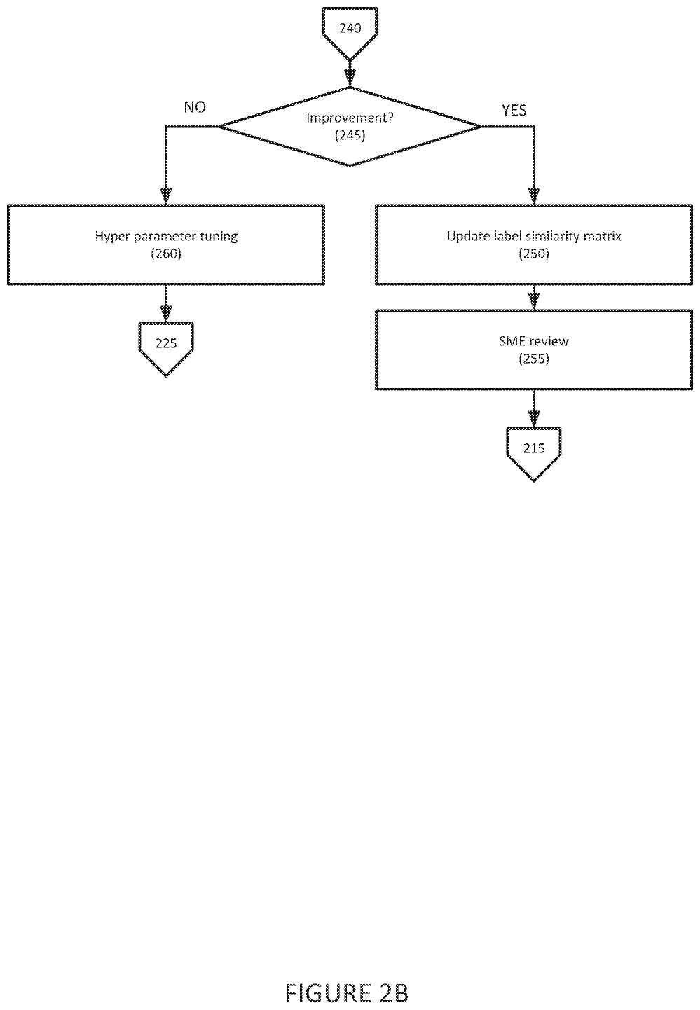

Referring to FIGS. 2A and 2B, a method for harnessing label semantics to extract higher performance under noisy label for company to industry matching is disclosed according to an embodiment.

In step 205, the computer program may receive training data. For example, the computer program may receive input data, such as company information, CBDs, their industry tags, the ITDs, etc.

In step 210, the computer program may create a similarity matrix for the industry tags using a minimum labeling strategy. For example, given N industry tags available, the similarity between each pair of tags is captured in an N*N matrix. In one embodiment, the similarity may be measured on a scale, such as between 0-5 (0—dissimilar, 5—similar). Other methods for measuring similarity may be used as is necessary and/or desired.

In embodiments, determining a similarity score may require domain specific knowledge and the volume of N*N may be large. Thus, SMEs may randomly label only a position (e.g., between 10-15%) of the industry tag pairs. This may be referred to as the Minimum Labelling Strategy.

For example, SMEs may label only ((N*(N+1))/2−N) cases (N much lesser than number of actual text records in a training sample). The labeling requirement may be even lesser due to model generalization effects.

An example matrix is provided below:

| | T1 | T2 | T3 | T4 |
|---|---|---|---|---|
| TI | Not rated | (0) | (1) | Not rated |
| T2 | Not rated | Not rated | Not rated | Not rated |
| T3 | Not rated | Not rated | Not rated | Not rated |
| T4 | Not rated | Not rated | Not rated | Not rated |

Note that NNR means “no need to rate”. T1, T2, T3, and T4 represent tags.

In step 215, the computer program may sample the industry tag pairs and their similarity scores from the similarity matrix. For example, the data may be sampled using a stratified sampling method. Given the similarity scores between industry tags are 0-5, there may be an equal number of samples corresponding to each score. The population of samples per score is determined so that there is coverage across industry tags.

In step 220, the computer program may create a dataset. In one embodiment, once the scores for industry tag pairs are collected, the computer program may generate a Semantic Textual Similarity (STS)-style dataset using the scores. A STS-style dataset consists of rows of triplets—Industry Tag Description, Company Business Description, and a Score. This is to enable STS evaluation.

Each industry tag may associate to an Industry Tag Description (ITD) that defines the tag. For example, an industry tag Financial Technology can be “Financial technology companies integrate predictive behavioral analytics, data driven marketing, blockchain to provide banking services.”

Each company may associate to a Company Business Description (CBD). For example: “ABC Pvt. Ltd. is a leading payment application based out of Bengaluru. It offers financial services through its mobile application and website for customers and vendors.”

For example, if a company ABC associates to Industry Tag T1, the Company Business Description of ABC would be similar to the Industry Tag Description of T1. Thus, the similarity scores corresponding to industry tag pairs may be used to quantify the similarity between company business descriptions and industry tag descriptions. A single model will see both domains of texts (i.e., CBD and ITD) and will be capable of producing robust embeddings for both.

In step 225, the computer program may fine tune a baseline language model and may train a semantic similarity model of which the baseline language model is a part. For example, embodiments may fine-tune the RoBERTa (Robustly Optimized BERT Pre-training Approach) model with financial domain data, such as text data that reference companies, business, industry, industry taxonomies, etc. The baseline language model may be fine-tuned to improve the overall understanding by the semantic similarity model.

In order to train the semantic similarity model, two embeddings generated for the pair of texts (Company Business Description and Industry Tag Description) may be subjected to a cosine similarity function. A mean square error loss function may be applied to regress over the model calculated similarity value and the ground truth.

Once done, a checkpoint model with the most optimized model for the semantic similarity model for an iteration may be created. In one embodiment, the most optimized model is the semantic similarity model having a minimum mean squared loss value.

In step 230, using the checkpoint model, the computer program may infer a label (e.g., an industry tag) for each company. For example, the checkpoint model may be provided with the industry tag descriptions, and a cosine similarity may be generated for the pair. This number is converted from −1 to 1 scale to 0-5 scale. This number may then be compared with the input ratings used for training the model for metric calculation.

In step 235, the computer program may evaluate the trained semantic similarity model. For example, the computer program may evaluate the Exact Match Ratio, or EMR, which may be defined as:

$$ExactMatchRatio , MR = \frac{1}{n} {\sum }_{i = 1}^{n} I ( {Y}_{i} = {Z}_{i} )$$

The computer program may convert the cosine similarity score generated by model to, for example, 0-5 scaled scores and may match those scores with those in an evaluation dataset (e.g., data from the training dataset that was not used for training). If the EMR of a particular round is greater than the previous round's EMR (indicating an improvement), the trained version of the semantic similarity model may be checkpointed.

In step 240, the computer program may update the similarity matrix. In one embodiment, the Cosine Similarity values generated for each Industry Tag Description pair may be converted to, for example, a 0-5 scale. The similarity matrix may be updated with these converted 0-5 scale values.

In step 245, the computer program may determine if there is an improvement in the model (i.e., an improvement in the EMR calculated using the checkpoint model). If the model did improve, in step 250, the cosine similarity value may be updated and then this matrix may be subjected to feedback from SMEs.

In step 255, the SMEs may verify the modified similarity matrix and randomly modify any ratings they find incorrect. These ratings are included into the training dataset for the next round. Stratified sampling may be applied and latest checkpoint model is finetuned with newly stratified dataset sample.

If the model does not show improvement, in step 260, the computer program may optimize the hyperparameters and observe for EMR improvements. For example, the hyperparameters may include epochs, batch size, learning rate, etc. These are standard across semantic similarity models. Once a model is trained with these optimized hyperparameters, the EMR for that model may be calculated. The EMR calculated using this new model is compared to the EMR calculated using the old most optimal model. Thus, the EMR is the evaluation metric, whereas the hyperparameters help optimize the model.

The disclosure of each of U.S. Provisional patent application Ser. No. 63/256,996, filed Oct. 18, 2021, U.S. Provisional patent application Ser. No. 63/136,500 filed Jan. 12, 2021, and U.S. patent application Ser. No. 17/647,788, filed Jan. 12, 2022, is hereby incorporated, by reference, in its entirety.

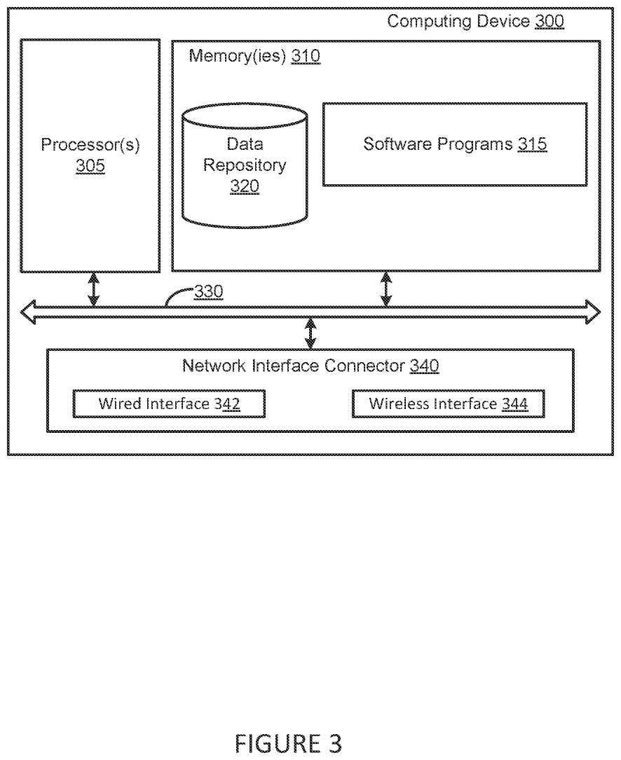

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by an electronic device, input data comprising company business descriptions, industry tags, and industry tag descriptions;
creating, by the computer program, a similarity matrix for the industry tags using a minimum labeling strategy, wherein the similarity matrix comprises a plurality of similarity scores for pairs of industry tags;
sampling, by the computer program, the industry tags using a stratified sampling method;
generating, by the computer program, a semantic textual similarity style dataset comprising triplets of the industry tag descriptions, the company business descriptions, and the similarity scores;
fine-tuning, by the computer program, a baseline language model for a semantic similarity model;
training, by the computer program, the semantic similarity model by subjecting embeddings generated for pairs of the company business description and industry tag descriptions to a cosine similarity function;
creating, by the computer program, a checkpoint model for the semantic similarity model, and
inferring, by the computer program, an industry tag for each company using the checkpoint model, wherein the checkpoint model generates a cosine similarity for pairs for industry tag descriptions.

2. The method of claim 1, further comprising:
evaluating, by the computer program, the checkpoint model using an Exact Match Ratio; and
updating, by the computer program, the similarity matrix using cosine similarity values for the pairs of industry tag descriptions.

3. The method of claim 2, wherein the computer program evaluates the checkpoint model by comparing the Exact Match Ratio for the checkpoint model to a prior Exact Match Ratio for a prior model to determine improvement in the checkpoint model.

4. The method of claim 3, further comprising:
optimizing, by the computer program, hyperparameters for the checkpoint model in response to the checkpoint model not improving relative to the prior model.

5. The method of claim 1, further comprising:
receiving, by the computer program, feedback for the inferred industry tags.

6. The method of claim 1, wherein the similarity scores are measured on a scale of between 0 and 5.

7. The method of claim 1, wherein the minimum labeling strategy receives between 10 percent and 15 percent of the similarity scores from subject matter experts.

8. The method of claim 1, wherein the stratified sampling method populates samples per similarity score such that each industry tag has a sample.

9. The method of claim 1, wherein the baseline language model comprises a Robustly Optimized BERT Pre-training Approach model.

10. The method of claim 1, wherein the baseline language model is fine-tuned with text data that reference companies, industries, and/or industry taxonomies.

11. A non-transitory computer readable storage medium, including instructions stored thereon, which when read and executed by one or more computer processors, cause the one or more computer processors to perform steps comprising:
receiving input data comprising company business descriptions, industry tags, and industry tag descriptions;
creating a similarity matrix for the industry tags using a minimum labeling strategy, wherein the similarity matrix comprises a plurality of similarity scores for pairs of industry tags;
sampling the industry tags using a stratified sampling method;
generating a semantic textual similarity style dataset comprising triplets of the industry tag descriptions, the company business descriptions, and the similarity scores;
fine-tuning a baseline language model for a semantic similarity model;
training the semantic similarity model by subjecting embeddings generated for pairs of the company business description and industry tag descriptions to a cosine similarity function;
creating checkpoint model for the semantic similarity model, and
inferring an industry tag for each company using the checkpoint model, wherein the checkpoint model generates a cosine similarity for pairs for industry tag descriptions.

12. The non-transitory computer readable storage medium of claim 11, further including instructions stored thereon, which when read and executed by one or more computer processors, cause the one or more computer processors to perform steps comprising:
evaluating the checkpoint model using an Exact Match Ratio; and
updating the similarity matrix using cosine similarity values for the pairs of industry tag descriptions.

13. The non-transitory computer readable storage medium of claim 12, wherein the checkpoint model is evaluated by comparing the Exact Match Ratio for the checkpoint model to a prior Exact Match Ratio for a prior model to determine improvement in the checkpoint model.

14. The non-transitory computer readable storage medium of claim 13, further including instructions stored thereon, which when read and executed by one or more computer processors, cause the one or more computer processors to perform steps comprising:
optimizing hyperparameters for the checkpoint model in response to the checkpoint model not improving relative to the prior model.

15. The non-transitory computer readable storage medium of claim 11, further including instructions stored thereon, which when read and executed by one or more computer processors, cause the one or more computer processors to perform steps comprising:
receiving feedback for the inferred industry tags.

16. The non-transitory computer readable storage medium of claim 11, wherein the similarity scores are measured on a scale of between 0 and 5.

17. The non-transitory computer readable storage medium of claim 11, wherein the minimum labeling strategy receives between 10 percent and 15 percent of the similarity scores from subject matter experts.

18. The non-transitory computer readable storage medium of claim 11, wherein the stratified sampling method populates samples per similarity score such that each industry tag has a sample.

19. The non-transitory computer readable storage medium of claim 11, wherein the baseline language model comprises a Robustly Optimized BERT Pre-training Approach model.

20. The non-transitory computer readable storage medium of claim 11, wherein the baseline language model is fine-tuned with text data that reference companies, industries, and/or industry taxonomies.
